(19) United States
(12) Patent Application Publication
(10) Pub. No.: US 2021/0130591 A1
(43) Pub. Date: May 6, 2021

(54) TIRE FOR A VEHICLE CARRYING HEAVY LOADS, COMPRISING A NEW TREAD

(71) Applicant: COMPAGNIE GENERALE DES ETABLISSEMENTS MICHELIN, Clermont-Ferrand (FR)

(72) Inventor: Etienne FLEURY, Clermont-Ferrand Cedex 9 (FR)

(73) Assignee: COMPAGNIE GENERALE DES ETABLISSEMENTS MICHELIN, Clermont-Ferrand (FR)

(21) Appl. No.: 16/471,537

(22) PCT Filed: Dec. 20, 2017
(86) PCT No.: PCT/FR2017/053744

§ 371 Date: Jun. 19, 2019

(30) Foreign Application Priority Data
Dec. 20, 2016 (FR) 1662909

(51) Int. Cl. C08L 9/06; C08C 19/25; B60C 1/00; B60C 11/00

(52) U.S. Cl. CPC C08L 9/06; C08C 19/25; B60C 1/0016; B60C 2011/0025; C08L 2205/03; B60C 2200/06; B60C 11/0008

(57) ABSTRACT

A tire intended to equip a vehicle bearing heavy loads is provided. The tire includes a tread having at least one rubber composition based on at least:
one elastomer matrix comprising at least one modified copolymer at a content greater than or equal to 51 phr, the modified copolymer having a glass transition temperature Tg above −65° C. and below or equal to −30° C. and being composed of a copolymer based on styrene and based on butadiene functionalized in the middle of the chain with an alkoxysilane group linking the two arms of the copolymer via the silicon atom which bears an amine function bonded directly or via a spacer group to the silicon atom,
a reinforcing filler,
a chemical crosslinking system,
an agent for coupling, and
a plasticizing system comprising from 2 to 15 phr of at least one plasticizing resin.

This application is a 371 national phase entry of PCT/FR2017/053744 filed on 20 Dec. 2017, which claims benefit of French Patent Application No. 1662909, filed 20 Dec. 2016, the entire contents of which are incorporated herein by reference for all purposes.

### BACKGROUND

### 1. Technical Field

The field of the present invention is that of tires for vehicles bearing heavy loads, in particular heavy-duty vehicles, buses, civil engineering vehicles, etc.

### 2. Related Art

Their tires intended for vehicles bearing heavy loads have specific dimensional, robustness and structural features which distinguish them from other tires, in particular from tires for equipping passenger vehicles. Their treads must comply with a large number of technical performance qualities that are often contradictory, in particular high wet grip, low rolling resistance and good wear strength.

Specifically, certain vehicles bearing heavy loads are intended to run over increasingly long journeys, because of improvements to the road network and the growth of motorway networks worldwide. For safety reasons, the wet grip must be high. Moreover, the wear of these tire treads must be as low as possible, as must the rolling-related energy losses.

However, it is well known to a person skilled in the art that the improvement in one performance quality for tires is often obtained to the detriment of the other performance qualities.

For example, one way of giving a tire high wet grip is to use, for the tread, a rubber composition which has a good hysteretic potential. However, at the same time, this tread must have the lowest possible contribution to the rolling resistance to limit the rolling-related energy losses; i.e. it must have the least possible hysteresis.

Another example of contradictory performance qualities is the following. To improve the wear strength, a person skilled in the art knows that it is necessary for the tread to have good stiffness. Such stiffness may be obtained especially by increasing the content of reinforcing filler in the rubber compositions which constitute these treads. However, increasing this content of reinforcing fillers gives rise to an increase in the hysteresis of the tire and thus a risk of penalizing the rolling resistance properties.

There is thus an ongoing need to provide a tire for vehicles bearing heavy loads having a tread whose wet grip is high, without the rolling resistance and the wear strength being penalized.

### SUMMARY

In the light of the foregoing, one object is to provide a tire intended to equip a vehicle bearing heavy loads, this tire including a tread which satisfies a compromise of wet grip/rolling resistance/wear strength performance qualities.

The Applicants have discovered in the course of their research that the specific combination of a modified copolymer based on styrene and butadiene, of a reinforcing filler predominantly comprising silica and of a plasticizing system at a specific content makes it possible to obtain a rubber composition which can be used in the tread of a tire for vehicles bearing heavy loads, which satisfies this problem.

Thus, the invention relates to a tire intended to equip a vehicle bearing heavy loads, this tire including a tread having at least one rubber composition based on at least:
an elastomer matrix comprising at least one modified copolymer at a content greater than or equal to 51 phr, said modified copolymer having a glass transition temperature Tg strictly above −65° C. and below or equal to −30° C. and being composed of a copolymer based on styrene and based on butadiene functionalized in the middle of the chain with an alkoxysilane group linking the two arms of said copolymer via the silicon atom which bears an amine function bonded directly or via a spacer group to the silicon atom,
a reinforcing filler predominantly comprising silica,
a chemical crosslinking system,
an agent for coupling between said elastomeric matrix and said reinforcing filler,
a plasticizing system comprising from 2 to 15 phr, preferably from 2 to 10 phr, of at least one plasticizing resin having a glass transition temperature Tg of greater than or equal to 20° C., and of which the total content of the plasticizing system in the composition ranges from 2 to 17 phr, preferably from 2 to 12 phr.

Preferentially, the amine function of said modified copolymer is a primary, secondary or tertiary amine.

Preferentially, the amine function of said modified copolymer is a tertiary amine and is chosen from diethylamine and dimethylamine.

Preferentially, the amine function of said modified copolymer is borne by the alkoxysilane group via a spacer group.

Preferentially, the spacer group bearing the amine function of the modified copolymer is a C₁-C₁₈ aliphatic hydrocarbon-based radical, preferably a C₂ or C₃ linear hydrocarbon-based radical.

Preferentially, the alkoxysilane group of the modified copolymer is methoxysilane or ethoxysilane, optionally partially or totally hydrolysed to silanol.

Preferentially, the copolymer based on styrene and based on butadiene functionalized in the middle of the chain with an alkoxysilane group linking the two arms of said copolymer via the silicon atom which bears an amine function bonded directly or via a spacer group to the silicon atom is the predominant species of the modified copolymer.

Preferentially, the modified copolymer has a glass transition temperature ranging from −60° C. to −40° C.

Preferentially, the elastomer matrix also comprises at least one second diene elastomer different from the modified copolymer.

Preferentially, the second diene elastomer is chosen from the group formed by polybutadienes, natural rubber, synthetic isoprenes, butadiene copolymers other than butadiene-styrene copolymers, isoprene copolymers and mixtures of these polymers and copolymers; preferably the second diene elastomer is a polybutadiene.

Preferentially, the content of the second diene elastomer ranges from 5 to 49 phr, preferably from 15 to 35 phr.

Preferentially, the composition also comprises carbon black.

Preferentially, the content of the reinforcing filler ranges from 55 to 200 phr, preferably from 55 to 150 phr, more preferably from 55 to 80 phr.

Preferentially, the plasticizing resin has a glass transition temperature Tg of greater than or equal to 30° C., preferably ranging from 30 to 100° C.

Preferentially, the plasticizing resin is chosen from the group consisting of cyclopentadiene homopolymer or copolymer resins, dicyclopentadiene homopolymer or copolymer resins, terpene homopolymer or copolymer resins, C₅ fraction homopolymer or copolymer resins, C₉ fraction homopolymer or copolymer resins, mixtures of C₅ fraction homopolymer or copolymer resins and of C₉ fraction homopolymer or copolymer resins, α-methylstyrene homopolymer or copolymer resins, and mixtures of these resins.

Preferentially, the plasticizing system comprises from 0 to 2 phr of at least one plasticizing agent that is liquid at room temperature.

Preferentially, the composition is free of a plasticizing agent that is liquid at room temperature.

Preferentially, the tire as defined above is intended to equip a heavy-duty vehicle or a bus.

### I—DETAILED DESCRIPTION OF EXAMPLE EMBODIMENTS

The invention relates to a tire intended to equip a vehicle bearing heavy loads, this tire comprising a tread including at least one rubber composition based on at least:
an elastomer matrix comprising at least one modified copolymer at a content greater than or equal to 51 phr, said modified copolymer having a glass transition temperature Tg strictly above −65° C. and below or equal to −30° C. and being composed of a copolymer based on styrene and based on butadiene functionalized in the middle of the chain with an alkoxysilane group linking the two arms of said copolymer via the silicon atom which bears an amine function bonded directly or via a spacer group to the silicon atom,
a reinforcing filler predominantly comprising silica,
a chemical crosslinking system,
an agent for coupling between said elastomeric matrix and said reinforcing filler,
a plasticizing system comprising from 2 to 15 phr, preferably from 2 to 10 phr, of at least one plasticizing resin having a glass transition temperature Tg of greater than or equal to 20° C., and of which the total content of the plasticizing system in the composition ranges from 2 to 17 phr, preferably from 2 to 12 phr.

In the present description, unless expressly indicated otherwise, all the percentages (%) shown are percentages by weight.

Furthermore, any range of values denoted by the expression “between a and b” represents the range of values extending from more than “a” to less than “b” (that is to say, limits a and b excluded), while any range of values denoted by the expression “from a to b” means the range of values extending from “a” up to “b” (that is to say, including the strict limits a and b).

The abbreviation “phr” (per hundred parts of rubber) means parts by weight per hundred parts of elastomers (of the total of the elastomers, if several elastomers are present) or rubber present in the rubber composition.

The term “tire intended to equip a vehicle bearing heavy loads” generally means any tire intended to equip heavy-duty vehicles, buses, civil engineering vehicles, agricultural vehicles or aeroplanes. The invention is particularly well suited to tires intended to equip heavy-duty vehicles.

The term “rubber composition based on” should be understood as meaning a rubber composition including the mixture and/or the reaction product of the various constituents used, some of these base constituents being capable of reacting, or intended to react, with one another, at least in part, during the various phases of manufacture of the composition, in particular during the crosslinking or vulcanization thereof.

The term “elastomer matrix” or “elastomeric matrix” means all of the modified or unmodified elastomer(s) present in the rubber composition.

The term “elastomer” (or, equally, rubber), whether natural or synthetic, should be understood to mean an elastomer consisting at least in part (that is to say a homopolymer or a copolymer) of diene monomer(s) (i.e. monomer(s) bearing two conjugated or non-conjugated carbon-carbon double bonds). These elastomers are also referred to as diene elastomers.

These diene elastomers can be classified into two categories: “essentially unsaturated” or “essentially saturated”. “Essentially unsaturated” generally refers to a diene elastomer resulting at least in part from conjugated diene monomers having a content of units of diene origin (conjugated dienes) which is greater than 15% (molar percentage); thus it is that diene elastomers such as butyl rubbers or copolymers of dienes and of alpha-olefins of EPDM type do not come within the preceding definition and can in particular be described as “essentially saturated” diene elastomers (low or very low content, always less than 15 mol %, of units of diene origin). In the category of “essentially unsaturated” diene elastomers, the term “highly unsaturated” diene elastomer refers in particular to a diene elastomer having a content of units of diene origin (conjugated dienes) which is greater than 50% (molar percentage).

Given these definitions, the term “diene elastomer that can be used in the compositions in accordance with the invention” more particularly means:
(a)—any homopolymer of a conjugated diene monomer, in particular any homopolymer obtained by polymerization of a conjugated diene monomer containing from 4 to 12 carbon atoms;
(b)—any copolymer obtained by copolymerization of one or more conjugated dienes with each other or with an ethylene monomer or with one or more vinylaromatic compounds containing from 8 to 20 carbon atoms;
(c)—a ternary copolymer obtained by copolymerization of ethylene and of an α-olefin containing from 3 to 6 carbon atoms with a non-conjugated diene monomer containing from 6 to 12 carbon atoms, for instance the elastomers obtained from ethylene and propylene with a non-conjugated diene monomer of the abovementioned type, such as, in particular, 1,4-hexadiene, ethylidenenorbornene or dicyclopentadiene;
(d)—a copolymer of isobutene and of isoprene (butyl rubber) and also the halogenated versions, in particular chlorinated or brominated versions, of this type of copolymer.

Although it applies to any type of diene elastomer, a person skilled in the art will understand that the present invention is preferably implemented with essentially unsaturated diene elastomers, in particular of the above type (a) or (b).

The diene elastomers may have any microstructure, which depends on the polymerization conditions used, especially on the presence or absence of a modifying and/or randomizing agent and on the amounts of modifying and/or randomizing agent employed. The diene elastomers may, for example, be block, random, sequential or microsequential elastomers and may be prepared in dispersion or in solution; they may be coupled and/or star-branched or else functionalized with a coupling and/or star-branching or functionalization agent. For coupling to a reinforcing inorganic filler such as silica, mention may be made, for example, of silanol or polysiloxane functional groups bearing a silanol end (as described, for example, in FR 2 740 778 or U.S. Pat. No. 6,013,718, and WO 2008/141702), alkoxysilane groups (as described, for example, in FR 2 765 882 or U.S. Pat. No. 5,977,238), carboxyl groups (as described, for example, in WO 01/92402 or U.S. Pat. No. 6,815,473, WO 2004/096865 or US 2006/0089445) or else polyether groups (as described, for example, in EP 1 127 909 or U.S. Pat. No. 6,503,973, WO 2009/000750 and WO 2009/000752).

As functional diene elastomers, mention may also be made of those prepared using a functional initiator, especially those bearing an amine or tin function (see, for example, WO 2010/072761).

Mention may also be made, as other examples of functionalized diene elastomers, of elastomers (such as BR, NR or IR) of the epoxidized type.

For the purposes of the present invention, the term “predominantly” means that the compound is predominant among the compounds of the same type in the composition, that is to say that it is the one which represents the greatest amount by mass among the compounds of the same type. In other words, the mass of this compound represents at least 51% of the total mass of the compounds of the same type in the composition. By way of example, in a system comprising just one elastomer, the latter is predominant within the meaning of the present invention; and in a system comprising two elastomers, the predominant elastomer represents more than half of the total mass of the elastomers, in other words the mass of this elastomer represents at least 51% of the total mass of the elastomers. In the same way, a “predominant” filler is the one representing the greatest mass among the fillers of the composition. In other words, the mass of this filler represents at least 51% of the total mass of the fillers in the composition.

The term “minor” refers to a compound which does not represent the greatest fraction by mass among the compounds of the same type.

All the glass transition temperature “Tg” values are measured in a known manner by DSC (Differential Scanning calorimetry) according to the standard ASTM D3418 (1999).

The term “free of compound X” means that compound X is not detectable by measures known to a person skilled in the art or that this compound X is present in small amounts that represent impurities (i.e. of the order of ppm (parts per million by weight)).

Within the context of the invention, the carbon-based products mentioned in the description may be of fossil or biosourced origin. In the latter case, they may partially or completely result from biomass or be obtained from renewable starting materials derived from biomass. The compounds (such as monomers, polymers), the reagents and other components mentioned in the description, such as the plasticizing agents, fillers, etc., are concerned in particular.

### Modified Copolymer

The elastomeric matrix of the rubber composition of the tire in accordance with the invention comprises at least one modified copolymer at a content greater than or equal to 51 phr, said modified copolymer has a glass transition temperature Tg strictly above −65° C. and below or equal to −30° C. and is composed of a copolymer based on styrene and based on butadiene functionalized in the middle of the chain with an alkoxysilane group linking the two arms of said copolymer via the silicon atom which bears an amine function bonded directly or via a spacer group to the silicon atom.

The term “copolymer based on styrene and butadiene” means herein a copolymer resulting from the polymerization of at least one styrene monomer and of at least one butadiene monomer (and, of course, also any mixture of such copolymers). The following are suitable in particular as styrene monomers: styrene, methylstyrenes, para-tert-butylstyrene, methoxystyrenes or chlorostyrenes. The following are suitable in particular as butadiene monomers: 1,3-butadiene, 2-methyl-1,3-butadiene, 2,3-di(C₁-C₅ alkyl)-1,3-butadienes, for instance 2,3-dimethyl-1,3-butadiene, 2,3-diethyl-1,3-butadiene, 2-methyl-3-ethyl-1,3-butadiene, 2-methyl-3-isopropyl-1,3-butadiene and an aryl-1,3-butadiene.

Among the copolymers based on styrene and butadiene, mention may be made especially of those with a styrene content of between 5% and 60% by weight and more particularly between 20% and 50% by weight relative to the weight of the copolymer, a molar content (mol %) of 1,2-bonds of the butadiene part of between 4% and 75%, and a molar content (mol %) of trans-1,4-bonds of the butadiene part of between 10% and 80%. The weight content of styrene, the molar content of 1,2-bonds of the butadiene part and the molar content of trans-1,4-bonds are measured by techniques well known to those skilled in the art.

Preferably, the copolymer based on styrene and butadiene is constituted of styrene monomers and of butadiene monomers, i.e. the sum of the molar percentages of styrene monomers and of butadiene monomers is equal to 100%.

In the rest of the description, for the sake of simplicity, the expression “copolymer based on styrene and butadiene” is used to denote a copolymer comprising styrene monomers and butadiene monomers and a copolymer constituted of styrene monomers and of butadiene monomers.

For the purposes of the present invention, the term “copolymer based on styrene and butadiene functionalized in the middle of the chain” means a copolymer based on styrene and butadiene bearing a functional group which is located in the main chain of the copolymer.

It will be equivalently stated that the copolymer is coupled or else functionalized in the middle of the chain (although the functional group is not precisely in the middle of the elastomer chain) as opposed to a copolymer functionalized at the chain end or terminal.

Specifically, in general, when a functional group is located at the end of an elastomer chain, the elastomer is then said to be functionalized at the chain end or terminal.

Similarly, when a functional group is in a central position to which at least three elastomer arms are linked forming a star-branched structure of the elastomer, the elastomer will be said to be star-branched.

The copolymer based on styrene and butadiene functionalized in the middle of the chain used in the context of the invention is obtained by modification of the copolymer based on styrene and butadiene with a functionalizing agent on the living copolymer obtained from the anionic polymerization step.

The resulting modified copolymer is composed of a copolymer based on styrene and butadiene functionalized in the middle of the chain with an alkoxysilane group linking the two arms of said copolymer via the silicon atom which bears an amine function bonded directly or via a spacer group to the silicon atom. This modified copolymer has a glass transition temperature Tg strictly above −65° C. and below or equal to −30° C. Preferably, the glass transition temperature Tg of said modified copolymer may range from −60° C. to −40° C. A person skilled in the art knows how to modify the microstructure of a copolymer based on styrene and butadiene in order to adjust its Tg, in particular by varying the contents of styrene, of 1,2-bonds of the butadiene part or else of trans-1,4-bonds of the butadiene part. A person skilled in the art also knows that the resulting modified copolymer is composed, i.e. formed, from one or more copolymers based on styrene and butadiene functionalized in the middle of the chain with an alkoxysilane group linking the two arms of said copolymer via the silicon atom which bears an amine function bonded directly or via a spacer group to the silicon atom.

In the present description, the notion of an alkoxysilane group functionalizing the modified copolymer in the middle of the chain is understood as being a group in which the silicon atom is located in the backbone of said copolymer and directly connected thereto. The alkoxysilane group is not a side group.

Preferentially, in the alkoxysilane group, the alkoxyl radical, optionally partially or totally hydrolysed to hydroxyl, comprises a C₁-C₁₀ or even C₁-C₈ and preferably C₁-C₄ alkyl radical; more preferentially, the alkoxyl radical is a methoxy or an ethoxy.

The modified elastomer used in the context of the invention also comprises an amine function borne by the alkoxysilane group. The amine function is borne by the silicon of the alkoxysilane group, directly or via a spacer group.

According to one embodiment, the alkoxysilane group may be represented by the formula

(*-)₂Si(OR)X

in which:
*- represents the bond to an elastomer chain;
in the alkoxyl radicals of formula —OR, optionally partially or totally hydrolysed to hydroxyl, R represents a substituted or unsubstituted alkyl radical, which is C₁-C₁₀, or even C₁-C₈, preferably a C₁-C₄ alkyl radical, more preferentially methyl and ethyl;
X represents the amine function.

Amine functions that may be mentioned include primary amines, which may or may not be protected with a protecting group, secondary amines, which may or may not be protected with a protecting group, or tertiary amines.

Thus, as secondary or tertiary amine function, mention may be made of amines substituted with C₁-C₁₀ alkyl, preferably C₁-C₄ alkyl radicals, more preferentially a methyl or ethyl radical, or alternatively cyclic amines forming a heterocycle containing a nitrogen atom and at least one carbon atom, preferably from 2 to 6 carbon atoms. For example, methylamino-, dimethylamino-, ethylamino-, diethylamino-, propylamino-, dipropylamino-, butylamino-, dibutylamino-, pentylamino-, dipentylamino-, hexylamino-, dihexylamino- and hexamethyleneamino- groups are suitable for use, preferably diethylamino- and dimethylamino- groups. When the amine is cyclic, morpholine, piperazine, 2,6-dimethylmorpholine, 2,6-dimethylpiperazine, 1-ethylpiperazine, 2-methylpiperazine, 1-benzylpiperazine, piperidine, 3,3-dimethylpiperidine, 2,6-dimethylpiperidine, 1-methyl-4-(methylamino)piperidine, 2,2,6,6-tetramethylpiperidine, pyrrolidine, 2,5-dimethylpyrrolidine, azetidine, hexamethyleneimine, heptamethyleneimine, 5-benzyloxyindole, 3-azaspiro[5,5]undecane, 3-azabicyclo[3.2.2]nonane, carbazole, bistrimethylsilylamine, pyrrolidine and hexamethyleneamine are also suitable for use, preferably pyrrolidine and hexamethyleneamine groups.

Preferably, the amine function is a tertiary amine function, preferably diethylamine or dimethylamine.

According to one variant, the amine function is directly bonded to the silicon atom, which is itself directly integrated into the elastomer chain.

According to another variant, the amine function is borne by the alkoxysilane group via a spacer group which may be an atom, especially a heteroatom, or a group of atoms which bonds the amine function to the silicon atom. The spacer group may be a linear or branched, C₁-C₁₈ aliphatic, saturated or unsaturated, cyclic or non-cyclic divalent hydrocarbon-based radical, or a C₆-C₁₈ aromatic divalent hydrocarbon-based radical and may contain one or more aromatic radicals and/or one or more heteroatoms. The hydrocarbon-based radical may optionally be substituted.

According to a preferred variant, the spacer group is a linear or branched, C₁-C₁₈ aliphatic divalent hydrocarbon-based radical, more preferentially a divalent aliphatic hydrocarbon-based radical, even more preferentially a linear C₂ or C₃ divalent hydrocarbon-based radical.

The various preceding aspects, which may or may not be preferential, and which especially concern the nature of the function comprising a nitrogen atom, the nature of the spacer group, the nature of the alkoxysilane group and the nature of the copolymer based on styrene and butadiene may be combined together, provided that they are compatible.

The modified copolymer according to the invention may be obtained via a general process as described below. A person skilled in the art knows how to adapt this general process to the particular copolymer which is the copolymer based on styrene and based on butadiene having a glass transition temperature Tg strictly above −65° C. and below or equal to −30° C.

The first step of a process for preparing the modified diene elastomer is the anionic polymerization of at least one styrene monomer and one butadiene monomer in the presence of a polymerization initiator. The monomers are as described above.

As polymerization initiator; use may be made of any known monofunctional anionic initiator. However, an initiator containing an alkali metal such as lithium is preferentially used.

As organolithium initiators, those including a carbon-lithium bond or amine-lithium bond are especially suitable for use. Representative compounds of polymerization initiators including a carbon-lithium bond are aliphatic organolithiums such as ethyllithium, n-butyllithium (n-BuLi), isobutyllithium, etc.

Representative compounds of polymerization initiators including an amine-lithium bond are, preferably, lithium amides, produced from the reaction of an organolithium compound, preferably an alkyllithium, and an acyclic or cyclic, preferably cyclic, secondary amine.

The polymerization is preferably performed in the presence of an inert hydrocarbon-based solvent, which may be, for example, an aliphatic or alicyclic hydrocarbon such as pentane, hexane, heptane, isooctane, cyclohexane, methylcyclohexane or an aromatic hydrocarbon such as benzene, toluene, xylene.

The microstructure of the copolymer may be determined by the presence or absence of a modifying and/or randomizing agent and the amounts of modifying and/or randomizing agent used. Preferentially, when the diene elastomer is based on butadiene and styrene, a polar agent is used during the polymerization step in amounts such that it promotes the statistical distribution of the styrene along the polymer chains.

Advantageously, the living copolymer derived from the polymerization is then functionalized by means of a functionalizing agent that is capable of introducing an amino alkoxysilane group into the copolymer structure to prepare the modified copolymer according to the invention.

The reaction for modification of the living copolymer, obtained on conclusion of the first step, may proceed at a temperature of between −20° C. and 100° C., by addition to the living polymer chains or, conversely, of a non-polymerizable functionalizing agent which is capable of forming an alkoxysilane group, the silicon atom being integrated into the elastomer chain, bearing an amine function. It is particularly a functionalizing agent bearing functions that are reactive towards the living elastomer, each of these functions being directly bonded to the silicon atom.

Thus, according to a preferred variant of the process for synthesizing the modified copolymer used in the context of the invention, the functionalizing agent corresponds to the formula:

(OR′)₃SiX

in which:
in the alkoxyl radicals of formula —OR′, R′ represents a substituted or unsubstituted C₁-C₁₀ or even C₁-C₈ alkyl radical, preferably a C₁-C₄ alkyl group, more preferentially methyl and ethyl;
X represents a group including an amine function.

Preferentially, the amine function is a protected or unprotected primary amine, a protected or unprotected secondary amine, or a tertiary amine. The nitrogen atom may then be substituted with two groups, which may be identical or different, which may be a trialkylsilyl radical, the alkyl group containing 1 to 4 carbon atoms, or a C₁-C₁₀ alkyl, preferably C₁-C₄ alkyl radical, more preferentially a methyl or ethyl radical, or else the two substituents of the nitrogen form therewith a heterocycle containing a nitrogen atom and at least one carbon atom, preferably from 2 to 6 carbon atoms.

Examples of functionalizing agents that may be mentioned include (N,N-dialkylaminoalkyl)trialkoxysilanes, (N-alkylaminoalkyl)trialkoxysilanes in which the secondary amine function is protected with a trialkylsilyl group and (aminoalkyl)trialkoxysilanes in which the primary amine function is protected with two trialkylsilyl groups, the divalent hydrocarbon-based group making it possible to bond the amine function to the trialkoxysilane group is the spacer group as described above, preferentially C₁-C₁₈ aliphatic, more particularly linear C₂ or C₃.

Advantageously, the functionalizing agent is chosen from (N,N-dialkylaminoalkyl)trialkoxysilanes.

Thus, the functionalizing agent may be chosen from 3-(N,N-dimethylaminopropyl)trimethoxysilane, 3-(N,N-dimethylaminopropyl)triethoxysilane, 3-(N,N-diethylaminopropyl)trimethoxysilane, 3-(N,N-diethylaminopropyl)triethoxysilane, 3-(N,N-di propylaminopropyl)trimethoxysilane, 3-(N,N-di propylaminopropyl)triethoxysilane, 3-(N,N-dibutylaminopropyl)trimethoxysilane, 3-(N,N-dibutylaminopropyl)triethoxysilane, 3-(N,N-dipentylaminopropyl)trimethoxysilane, 3-(N,N-dipentylaminopropyl)triethoxysilane, 3-(N,N-dihexylaminopropyl)trimethoxysilane, 3-(N,N-dihexylaminopropyl)triethoxysilane, 3-(hexamethyleneaminopropyl)trimethoxysilane, 3-(hexamethyleneaminopropyl)triethoxysilane, 3-(morpholinopropyl)trimethoxysilane, 3-(morpholinopropyl)triethoxysilane, 3-(piperidinopropyl)trimethoxysilane, 3-(piperidinopropyl)triethoxysilane. More preferentially, the functionalizing agent is 3-(N,N-dimethylaminopropyl)trimethoxysilane.

The functionalizing agent may also be chosen from 3-(N,N-methyltrimethylsilylaminopropyl)trimethoxysilane, 3-(N,N-methyltrimethylsilylaminopropyl)triethoxysilane, 3-(N,N-ethyltrimethylsilylaminopropyl)trimethoxysilane, 3-(N,N-ethyltrimethylsilylaminopropyl)triethoxysilane, 3-(N,N-propyltrimethylsilylaminopropyl)trimethoxysilane, 3-(N,N-propyltrimethylsilylaminopropyl)triethoxysilane. More preferentially, the functionalizing agent is 3-(N,N-methyltrimethylsilylaminopropyl)trimethoxysilane.

The functionalizing agent may also be chosen from 3-(N,N-bistrimethylsilylaminopropyl)trimethoxysilane and 3-(N,N-bistrimethylsilylaminopropyl)triethoxysilane. More preferentially, the functionalizing agent is 3-(N,N-bistrimethylsilylaminopropyl)trimethoxylsilane.

More particularly, the functionalizing agent is 3-(N,N-dimethylaminopropyl)trimethoxysilane.

The mole ratio of the functionalizing agent to the metal of the polymerization initiator is governed by the fact that the copolymer based on styrene and butadiene is functionalized in the middle of the chain. A person skilled in the art knows how to choose the appropriate mole ratio of the functionalizing agent.

According to one embodiment of the synthetic process, the alkoxysilane group advantageously includes an alkoxy radical, which is optionally partially or totally hydrolysed to hydroxyl.

According to the variants in which the functionalizing agent bears a protected amine function, the synthetic process may continue via a step of deprotecting this function. This step is performed after the modification reaction and is well known to those skilled in the art.

According to variants, the synthetic process may comprise a step of hydrolysis of the hydrolysable alkoxyl functions, by adding an acidic, basic or neutral compound as described in EP2266819 A1. The hydrolysable functions are then transformed into hydroxyl functions.

The process for synthesizing the modified copolymer may continue in a manner known per se via the steps of recovering the modified copolymer.

According to variants of this process, these steps comprise a stripping step in order to recover the copolymer derived from the preceding steps. This stripping step may have the effect of hydrolysing all or some of the hydrolysable functions of the modified copolymer. Advantageously, at least 50 mol % to 70 mol % of these functions may thus be hydrolysed.

According to one embodiment of the process, the mole ratio of the functionalizing agent to the metal of the polymerization initiator has a value ranging from 0.40 to 0.75, or even from 0.45 to 0.65, or else from 0.45 to 0.55. According to this embodiment, preferentially, the modified copolymer is predominantly functionalized in the middle of the chain with an alkoxysilane group linking the two arms of the diene elastomer via the silicon atom which bears an amine function bonded directly or via a spacer group to the silicon atom.

It should be pointed out that a person skilled in the art knows that when a copolymer is modified by reaction of a functionalizing agent on the living copolymer derived from a step of anionic polymerization, a mixture of modified species of this copolymer is obtained, the composition of which depends on the conditions of the modification reaction and especially on the proportion of reactive sites of the functionalizing agent relative to the number of living elastomer chains. This mixture comprises species functionalized at the chain end, coupled and star-branched. The modified copolymer is thus composed of copolymers functionalized at the chain end, copolymers functionalized in the middle of the chain and star-branched copolymers.

For the purposes of the present invention, the term “predominantly functionalized in the middle of the chain” means that, in the mixture of species of the modified copolymer obtained during the modification of the copolymer based on styrene and butadiene, the predominant species is the coupled species (or the species functionalized in the middle of the chain), i.e. the content of the coupled species is greater than or equal to 51% by weight relative to the total weight of the mixture of species of the modified copolymer.

Preferentially, the copolymer based on styrene and butadiene functionalized in the middle of the chain with an alkoxysilane group linking the two arms of the diene elastomer via the silicon atom which bears an amine function bonded directly or via a spacer group to the silicon atom represents at least 70% by weight of the modified copolymer.

According to particularly preferred embodiments, the modified copolymer based on styrene and butadiene functionalized in the middle of the chain with an alkoxysilane group bearing an amine function and having a glass transition temperature Tg strictly above −65° C. and below or equal to −30° C. is a copolymer based on styrene and butadiene for which at least one, at least two of the following characteristics is complied with, and preferably all of them:
the amine function is a tertiary amine, more particularly a diethylamino- or dimethylamino- group,
the amine function is borne by the alkoxysilane group via a spacer group which is a C₁-C₁₈ aliphatic hydrocarbon-based radical, even more preferentially a C₂ or C₃ linear hydrocarbon-based radical,
the alkoxysilane group is methoxysilane or ethoxysilane, optionally partially or totally hydrolysed to silanol.

Preferentially, the modified copolymer based on styrene and butadiene functionalized in the middle of the chain with an alkoxysilane group having a glass transition temperature Tg strictly above −65° C. and below or equal to −30° C. is a copolymer based on styrene and butadiene for which:
the amine function is borne by the alkoxysilane group via a linear C₃ hydrocarbon-based radical,
the amine function is a tertiary amine, more particularly a diethylamino- or dimethylamino- group;
the alkoxysilane group is methoxysilane or ethoxysilane, optionally partially or totally hydrolysed to silanol.

Even more preferentially, the modified copolymer based on styrene and butadiene predominantly functionalized in the middle of the chain with an alkoxysilane group and having a glass transition temperature Tg strictly above −65° C. and below or equal to −30° C. is a copolymer based on styrene and butadiene for which:
the amine function is borne by the alkoxysilane group via a linear C₃ hydrocarbon-based radical,
the amine function is a tertiary amine, more particularly a diethylamino- or dimethylamino- group;
the alkoxysilane group is methoxysilane or ethoxysilane, optionally partially or totally hydrolysed to silanol.

It will advantageously be noted that the rubber composition of the tire in accordance with the invention may not comprise, or may comprise in a very small amount, an extended copolymer based on styrene and butadiene; in other words, the content of extended copolymer based on styrene and butadiene, if this type of copolymer is present, may be less than or equal to 2 phr, so that this content may preferably correspond to an impurity. More particularly, the rubber composition of the tire in accordance with the invention may be free of extended copolymer based on styrene and butadiene. The term “extended copolymer” means a copolymer extended and stabilized with an oil, in particular of paraffinic, naphthenic or aromatic type.

Preferentially, the content of said modified elastomer in the rubber composition of the tire in accordance with the invention may range from 51 to 100 phr, preferably from 60 to 100 phr, even more preferably 60 to 85 phr.

The modified elastomer as defined above may advantageously be used as a blend (mixture) with one or more other diene elastomers different from said modified elastomer. In the case of a blend, it is in particular understood that the sum of the various elastomers used is equal to 100 phr.

Thus, in one embodiment of the tire in accordance with the invention, said modified elastomer above may optionally be combined with at least one second diene elastomer, different from said modified elastomer; that is to say that the second diene elastomer does not include any units derived from styrene and from butadiene. When it is present, the second diene elastomer may be chosen from the group consisting of polybutadienes (BRs), natural rubber (NR), synthetic isoprenes (IRs), butadiene copolymers other than butadiene-styrene copolymers, isoprene copolymers, and mixtures of these polymers and copolymers. Preferably, said second diene elastomer may be a polybutadiene (BR). When it is present, the content of the second diene elastomer may be at most equal to 49 phr, preferentially at most equal to 35 phr. Preferably, the content of the second diene elastomer may range from 5 to 49 phr (as a reminder, the term “phr” means parts by weight per hundred parts of elastomer, that is to say of the total of the elastomers present in the tread), preferably from 15 to 35 phr.

In another embodiment of the tire in accordance with the invention, said modified elastomer as described above may optionally be combined with at least one second diene elastomer, different from said modified elastomer (that is to say not including any units derived from styrene and from butadiene) and a third elastomer different from said copolymer based on styrene and butadiene and from the second diene elastomer. Preferably, the third diene elastomer may be an isoprene elastomer. Preferentially, the second diene elastomer may be chosen from the group consisting of polybutadienes (BRs) and butadiene copolymers other than butadiene-styrene copolymers; and the third diene elastomer may be chosen from the group consisting of natural rubber (NR), synthetic isoprenes (IRs), isoprene copolymers, and mixtures of these polymers and copolymers. Preferably, the second diene elastomer may be butadiene and the third diene elastomer may be natural rubber or a synthetic isoprene. Preferentially, the content of the second elastomer may range from 0.5 to 35 phr and the content of the third elastomer may range from 0.5 to 35 phr; more preferably the content of the second elastomer may range from 9 to 31 phr and the content of the third elastomer may range from 4 to 24 phr.

Among the polybutadienes or butadiene copolymers used in the above blends, the ones that are particularly suitable for use are polybutadienes with a content (mol %) of 1,2-units of between 4% and 80% or those with a content (mol %) of cis-1,4- units of greater than 80%, more particularly greater than 90%, butadiene-isoprene copolymers and especially those with an isoprene content of between 5% and 90% by weight and a Tg of −40° C. to −80° C., or isoprene-styrene copolymers and especially those with a styrene content of between 5% and 50% by weight and a Tg of between −25° C. and −50° C. In the case of butadiene-styrene-isoprene copolymers, the ones that are especially suitable for use are those with a styrene content of between 5% and 50% by weight and more particularly of between 10% and 40%, an isoprene content of between 15% and 60% by weight and more particularly of between 20% and 50%, a butadiene content of between 5% and 50% by weight and more particularly of between 20% and 40%, a content (mol %) of 1,2- units of the butadiene part of between 4% and 85%, a content (mol %) of trans-1,4- units of the butadiene part of between 6% and 80%, a content (mol %) of 1,2- plus 3,4- units of the isoprene part of between 5% and 70% and a content (mol %) of trans-1,4- units of the isoprene part of between 10% and 50%, and more generally any butadiene-styrene-isoprene copolymer with a Tg of between −20° C. and −70° C.

Among the isoprene elastomers (i.e., isoprene homopolymers or copolymers) used in the above blends, mention will be made in particular of NR, IR or isoprene copolymers, such as isobutene-isoprene (butyl rubber or IIR), isoprene-styrene (SIR), isoprene-butadiene (BIR) or isoprene-butadiene-styrene (SBIR) copolymers. Among these synthetic polyisoprenes, use may preferably be made of polyisoprenes with a content (mol %) of cis-1,4- bonds of greater than 90%, even more preferentially greater than 98%.

The diene elastomers described previously may also be combined, in a minority amount, with synthetic elastomers other than diene elastomers, or even polymers other than elastomers, for example thermoplastic polymers.

### Reinforcing Filler

The rubber composition used in the tires of the invention includes at least one reinforcing filler predominantly comprising silica, that is to say that the mass of silica represents at least 51% of the total mass of the constituents of the reinforcing filler. Preferably, the mass of silica represents more than 60%, preferably more than 70% of the total mass of the reinforcing filler.

In the present specification, the BET specific surface area is determined in a known manner by gas adsorption using the Brunauer-Emmett-Teller method described in The Journal of the American Chemical Society, Vol. 60, page 309, February 1938, more specifically according to French standard NF ISO 9277 of December 1996 (volumetric (5 point) method—gas: nitrogen—degassing: 1 hour at 160° C.—relative pressure p/po range: 0.05 to 0.17). The CTAB specific surface area is the external surface area determined according to French standard NF T45-007 of November 1987 (method B).

The term “reinforcing inorganic filler” should be understood here as meaning any inorganic or mineral filler, regardless of its colour and its origin (natural or synthetic), also known as “white filler”, “clear filler” or even “non-black filler”, in contrast to carbon black; this inorganic filler being capable of reinforcing by itself alone, without means other than an intermediate coupling agent, a rubber composition intended for the manufacture of tires, in other words capable of replacing, in its reinforcing role, a conventional tire-grade carbon black. Such a filler is generally characterized, in a known manner, by the presence of hydroxyl (—OH) groups at its surface, requiring, in order to be used as reinforcing filler, the use of a coupling agent or system intended to provide a stable chemical bond the filler and the elastomer matrix.

Mineral fillers of the siliceous type, preferentially silica (SiO₂), are especially suitable for use as inorganic reinforcing fillers. The silica used may be any reinforcing silica known to a person skilled in the art, in particular any precipitated or fumed silica with a BET specific surface area and also a CTAB specific surface area both of less than 450 m²/g, preferably from 30 to 400 m²/g, in particular between 60 and 300 m²/g. As highly dispersible precipitated silicas (“HDSs”), mention will be made, for example, of the Ultrasil 7000 and Ultrasil 7005 silicas from the company Evonik, the Zeosil 1165MP, 1135MP and 1115MP silicas and also the Zeosil Premium 200 silica from the company Solvay, the Hi-Sil EZ150G silica from the company PPG, the Zeopol 8715, 8745 and 8755 silicas from the company Huber or the silicas with a high specific surface area as described in patent application WO03/016837.

Needless to say, the term “reinforcing inorganic filler” is also understood to mean mixtures of various reinforcing inorganic fillers, in particular of highly dispersible silicas as described above or a mixture of inorganic fillers of siliceous type and of non-siliceous inorganic fillers. As non-siliceous inorganic fillers, mention may be made of mineral fillers of the aluminous type, in particular of alumina (Al₂O₃) or aluminium (oxides)hydroxides, or else reinforcing titanium oxides, for example described in U.S. Pat. Nos. 6,610,261 and 6,747,087. The non-siliceous inorganic fillers, when present, are in a minority amount in the reinforcing filler.

The physical state in which the inorganic reinforcing filler is provided is not important, whether it is in the form of a powder, of micropearls, of granules or else of beads.

According to one embodiment, the content of the reinforcing filler, in the rubber composition of the tire in accordance with the invention may range from 55 phr to 200 phr, preferably from 55 to 150 phr, more preferably ranges from 55 to 80 phr. These preferential ranges apply to any one of the embodiments of the invention.

A person skilled in the art will understand that use might be made, as filler equivalent to the reinforcing inorganic filler described in the present section, of a reinforcing filler of another nature, in particular organic nature, such as carbon black, provided that this reinforcing filler is covered with an inorganic layer, such as silica, or else includes, at its surface, functional sites, especially hydroxyl sites, requiring the use of a coupling agent in order to establish the bond between the filler and the elastomer. By way of example, mention may be made, for example, of carbon blacks for tires, as described, for example, in patent documents WO 96/37547 and WO 99/28380.

### Carbon Black:

According to one embodiment of the tire in accordance with the invention, the rubber composition may also comprise carbon black.

Carbon black, when it is present, may preferably be used at a content of less than or equal to 10 phr, preferably less than or equal to 5 phr. Preferably, the content of carbon black may range from 0.5 to 4 phr. These preferential ranges apply to any of the embodiments of the invention.

Any carbon black, especially the blacks conventionally used in tires or their treads (“tire-grade” blacks), are suitable for use as carbon blacks. Among the latter, mention will be made more particularly of the reinforcing carbon blacks of the 100, 200 and 300 series, or the blacks of the 500, 600 or 700 series (ASTM grades), for instance the N115, N134, N234, N326, N330, N339, N347, N375, N550, N683 and N772 blacks. These carbon blacks may be used in isolated form, as commercially available, or in any other form, for example as support for some of the rubber additives used.

### The Coupling Agents

To couple the reinforcing inorganic filler with the elastomer matrix (i.e. to the copolymer based on styrene and butadiene, in particular to the SBR and S-SBR, and to the diene elastomers, when they are present), use may be made, in a well-known manner, of an at least difunctional coupling agent (or bonding agent) intended to provide a satisfactory connection, of chemical and/or physical nature, between the inorganic filler (surface of its particles) and the elastomer matrix. Use may be made in particular of at least difunctional organosilanes or polyorganosiloxanes.

Use may be made especially of silane polysulfides, referred to as “symmetrical” or “asymmetrical” depending on their specific structure, as described, for example, in patent applications WO 03/002648 (or US 2005/016651) and WO 03/002649 (or US 2005/016650).

Suitable for use in particular, without the definition below being limiting, are silane polysulfides corresponding to the general formula (I) below:

Z-A-Sₓ-A-Z, (I)

in which:
x is an integer from 2 to 8 (preferably from 2 to 5);
the symbols A, which may be identical or different, represent a divalent hydrocarbon-based radical (preferably a C₁-C₁₈ alkylene group or a C₆-C₁₂ arylene group, more particularly a C₁-C₁₀, especially C₁-C₄, alkylene, in particular propylene);
the symbols Z, which may be identical or different, correspond to one of the three formulae below:

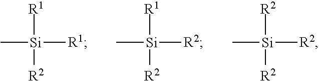

in which:
the radicals R¹, which may be substituted or unsubstituted and identical to or different from each other, represent a C₁-C₁₈ alkyl group, C₅-C₁₈ cycloalkyl group or C₆-C₁₈ aryl group (preferably C₁-C₆ alkyl, cyclohexyl or phenyl groups, especially C₁-C₄ alkyl groups, more particularly methyl and/or ethyl).
the radicals R², which may be substituted or unsubstituted and identical to or different from each other, represent a C₁-C₁₈ alkoxyl group or C₅-C₁₈ cycloalkoxyl group (preferably a group chosen from C₁-C₈ alkoxyls and C₅-C₈ cycloalkoxyls, even more preferentially a group chosen from C₁-C₄ alkoxyls, in particular methoxyl and ethoxyl).

In the case of a mixture of alkoxysilane polysulfides corresponding to the above formula (I), especially normal commercially available mixtures, the mean value of the “x” indices is a fractional number preferably between 2 and 5, more preferentially close to 4. However, the invention may also advantageously be performed, for example, with alkoxysilane disulfides (x=2).

As examples of silane polysulfides, mention will be made more particularly of bis((C₁-C₄)alkoxyl(C₁-C₄)alkylsilyl(C₁-C₄)alkyl) polysulfides (especially disulfides, trisulfides or tetrasulfides), for instance bis(3-trimethoxysilylpropyl) or bis(3-triethoxysilylpropyl) polysulfides. Among these compounds, use is made in particular of bis(3-triethoxysilylpropyl) tetrasulfide, abbreviated to TESPT, of formula [(C₂H₅O)₃Si(CH₂)₃S₂]₂, or bis(triethoxysilylpropyl) disulfide, abbreviated to TESPD, of formula [(C₂H₅O)₃Si(CH₂)₃S]₂. Mention will also be made, as preferential examples, of bis(mono(C₁-C₄)alkoxyldi(C₁-C₄)alkylsilylpropyl) polysulfides (especially disulfides, trisulfides or tetrasulfides), more particularly bis(monoethoxydimethylsilylpropyl) tetrasulfide, as described in the abovementioned patent application WO 02/083782 (or U.S. Pat. No. 7,217,751).

As examples of coupling agents other than an alkoxysilane polysulfide, mention will be made especially of difunctional POSs (polyorganosiloxanes) or hydroxysilane polysulfides (R²=OH in the above formula I) as described, for example, in patent applications WO 02/30939 (or U.S. Pat. No. 6,774,255), WO 02/31041 (or US 2004/051210), and WO 2007/061550, or else silanes or POSs bearing azodicarbonyl functional groups, as described, for example, in patent applications WO 2006/125532, WO 2006/125533, WO 2006/125534.

As examples of other silane sulfides, mention will be made, for example, of silanes bearing at least one thiol (—SH) function (referred to as mercaptosilanes) and/or at least one masked thiol function, as described, for example, in patents or patent applications U.S. Pat. No. 6,849,754, WO 99/09036, WO 2006/023815, WO 2007/098080, WO 2010/072685 and WO 2008/055986.

Needless to say, use could also be made of mixtures of the coupling agents described previously, as described especially in the abovementioned patent application WO 2006/125534.

The content of coupling agent is advantageously less than 20 phr, it being understood that it is generally desirable to use as little as possible thereof. Typically, the content of coupling agent represents from 0.5% to 15% by weight relative to the amount of inorganic filler. Its content is preferentially between 0.5 and 12 phr, more preferentially within a range extending from 3 to 10 phr. This content is readily adjusted by a person skilled in the art depending on the content of inorganic filler used in the composition. These preferential ranges apply to any of the embodiments of the invention.

### The Covering Agents:

These compositions may also contain, in addition to the coupling agents, coupling activators, agents for covering the inorganic fillers or more generally processing aids capable, in a known manner, by virtue of an improvement in the dispersion of the filler in the rubber matrix and of a lowering of the viscosity of the compositions, of improving their ability to be processed in the raw state, these agents being, for example, hydrolysable silanes, such as alkylalkoxysilanes, polyols, polyethers, primary, secondary or tertiary amines, or hydroxylated or hydrolysable polyorganosiloxanes.

### Plasticizing System

The rubber composition of the tires in accordance with the invention comprises from 2 to 17 phr of a plasticizing system, this system comprising from 2 to 15 phr of at least one plasticizing resin with a glass transition temperature Tg of greater than or equal to 20° C., and preferably from 0 to 2 phr of a plasticizing agent that is liquid at room temperature.

As is known to a person skilled in the art, the term “resin” is reserved in the present patent application, by definition, for a compound which is solid at room temperature (23° C.), in contrast with a plasticizing agent that is liquid at room temperature such as an oil.

Plasticizing resins are polymers that are well known to those skilled in the art. These are hydrocarbon-based resins essentially based on carbon and hydrogen, but which may include other types of atoms, which can be used in particular as plasticizing agents or tackifying agents in polymer matrices. They are by nature miscible (i.e. compatible) at the contents used with the compositions of diene elastomer(s) for which they are intended, so as to act as true diluents. They have been described, for example, in the publication entitled “Hydrocarbon Resins” by R. Mildenberg, M. Zander and G. Collin (New York, VCH, 1997, ISBN 3-527-28617-9), Chapter 5 of which is devoted to their applications, in particular in the tire rubber field (5.5. “Rubber Tires and Mechanical Goods”). They may be aliphatic, cycloaliphatic, aromatic, hydrogenated aromatic, or of the aliphatic/aromatic type, that is to say based on aliphatic and/or aromatic monomers. They may be natural or synthetic and are or are not based on petroleum (if such is the case, they are also known as petroleum resins). Their Tg is preferably greater than 0° C., in particular greater than 20° C. (most often between 30° C. and 95° C.).

In a known manner, these plasticizing resins may also be described as thermoplastic resins in the sense that they soften when heated and can thus be moulded. They may also be defined by a softening point or temperature. The softening point of a plasticizing resin is generally about 50 to 60° C. above its Tg value. The softening point is measured according to the standard ISO 4625 (ring and ball method). The macrostructure (Mw, Mn and PDI) is determined by size exclusion chromatography (SEC) as indicated below.

As a reminder, SEC analysis, for example, consists in separating the macromolecules in solution according to their size through columns filled with a porous gel; the molecules are separated according to their hydrodynamic volume, the bulkiest being eluted first. The sample to be analysed is simply dissolved beforehand in an appropriate solvent, tetrahydrofuran, at a concentration of 1 g/litre. The solution is then filtered through a filter with a porosity of 0.45 μm, before injection into the apparatus. The apparatus used is, for example, a “Waters Alliance” chromatographic line according to the following conditions: elution solvent: tetrahydrofuran; temperature 35° C.; concentration 1 g/litre; flow rate: 1 ml/min; volume injected: 100μl; Moore calibration with polystyrene standards; set of 3 “Waters” columns in series (“Styragel HR4E”, “Styragel HR1” and “Styragel HR 0.5”); detection by differential refractometer (for example, “Waters 2410”) which can be equipped with operating software (for example, “Waters Millenium”).

A Moore calibration is performed with a series of commercial polystyrene standards having a low PDI (less than 1.2), with known molar masses, covering the range of masses to be analysed. The mass-average molar mass (Mw), the number-average molar mass (Mn) and the polydispersity index (PDI=Mw/Mn) are deduced from the data recorded (curve of distribution by mass of the molar masses). All the molar mass values indicated in the present patent application are thus relative to calibration curves produced with polystyrene standards.

According to a preferred embodiment of the invention, the plasticizing resin may have at least any one of the following features:
a Tg of greater than or equal to 20° C. (in particular between 30° C. and 100° C.), more preferentially greater than or equal to 30° C. (in particular between 30° C. and 95° C.);
a softening point of greater than or equal to 40° C. (in particular between 40° C. and 150° C.);
a number-average molar mass (Mn) of between 400 and 2000 g/mol, preferentially between 500 and 1500 g/mol;
a polydispersity index (PDI) of less than 3, preferentially less than 2 (as a reminder: PDI=Mw/Mn with Mw the weight-average molar mass).

More preferentially, the plasticizing resin may have all of the above preferred features.

As examples of such plasticizing resins, mention may be made of those chosen from the group consisting of cyclopentadiene (abbreviated to CPD) homopolymer or copolymer resins, dicyclopentadiene (abbreviated to DCPD) homopolymer or copolymer resins, terpene homopolymer or copolymer resins, C₅ fraction homopolymer or copolymer resins, C₉ fraction homopolymer or copolymer resins, mixtures of C₅ fraction homopolymer or copolymer resins and of C₉ fraction homopolymer or copolymer resins, α-methylstyrene homopolymer or copolymer resins, and mixtures of these resins.

Among the above copolymer resins, mention may be made more particularly of those chosen from the group consisting of CPD/vinylaromatic copolymer resins, DCPD/vinylaromatic copolymer resins, CPD/terpene copolymer resins, DCPD/terpene copolymer resins, terpene/phenol copolymer resins, CPD/C₅ fraction copolymer resins, DCPD/C₅ fraction copolymer resins, CPD/C₉ fraction copolymer resins, DCPD/C₉ fraction copolymer resins, mixtures of C₅ fraction and C₉ fraction resins, terpene/vinylaromatic copolymer resins, terpene/phenol copolymer resins, C₅ fraction/vinylaromatic copolymer resins, and mixtures of these resins.

The term “terpene” groups together here, in a known manner, α-pinene, β-pinene and limonene monomers; use is preferentially made of a limonene monomer, a compound which exists, in a known manner, in the form of three possible isomers: L-limonene (laevorotatory enantiomer), D-limonene (dextrorotatory enantiomer), or else dipentene, the racemate of the dextrorotatory and laevorotatory enantiomers. Suitable as vinylaromatic monomer are, for example: styrene, α-methylstyrene, ortho-methylstyrene, meta-methylstyrene, para-methylstyrene, vinyltoluene, para(tert-butyl)styrene, methoxystyrenes, chlorostyrenes, hydroxystyrenes, vinylmesitylene, divinylbenzene, vinylnaphthalene or any vinylaromatic monomer derived from a C₉ fraction (or more generally from a C₈ to C₁₀ fraction).

More particularly, mention may be made of resins chosen from the group consisting of CPD homopolymer resins, DCPD homopolymer resins, CPD/styrene copolymer resins, DCPD/styrene copolymer resins, polylimonene resins, limonene/styrene copolymer resins, limonene/CPD copolymer resins, limonene/DCPD copolymer resins, C₅ fraction/styrene copolymer resins, C₅ fraction/C₉ fraction copolymer resins, and mixtures of these resins.

All the above resins are well known to a person skilled in the art and are commercially available, for example sold by the company DRT under the name Dercolyte as regards polylimonene resins, by the company Neville Chemical Company under the name Super Nevtac, by Kolon under the name Hikorez or by the company ExxonMobil under the name Escorez as regards C₅ fraction/styrene resins or C₅ fraction/C₉ fraction resins, or else by the company Struktol under the name 40 MS or 40 NS (mixtures of aromatic and/or aliphatic resins).

According to one embodiment of the invention, the plasticizing system may moreover include a plasticizing agent that is liquid at room temperature (at 23° C.) present in a content of less than or equal to 2 phr.

Any extender oil, whether it is of aromatic or non-aromatic nature, or any plasticizing agent that is liquid at room temperature known for its plasticizing properties with regard to diene elastomers may be able to be used in addition to the plasticizing resin. At room temperature (23° C.), these plasticizing agents or these oils, which are more or less viscous, are liquids (that is to say, as a reminder, substances which have the ability to eventually take on the shape of their container), as opposed, in particular, to plasticizing hydrocarbon-based resins, which are by nature solids at room temperature.

As plasticizing agents that are liquid at room temperature, mention may be made especially of liquid diene polymers, polyolefin oils, naphthenic oils, paraffinic oils, DAE (Distillate Aromatic Extracts) oils, MES (Medium Extracted Solvates) oils, TDAE (Treated Distillate Aromatic Extracts) oils, RAE (Residual Aromatic Extract oils) oils, TRAE (Treated Residual Aromatic Extract) oils, SRAE (Safety Residual Aromatic Extract oils) oils, mineral oils, vegetable oils, ether plasticizing agents, ester plasticizing agents, phosphate plasticizing agents, sulfonate plasticizing agents, and mixtures of these compounds. According to a more preferred embodiment, the plasticizing agent that is liquid at room temperature is chosen from the group consisting of MES oils, TDAE oils, naphthenic oils, vegetable oils, and mixtures of these oils.

In one embodiment, the rubber composition of tires in accordance with the invention may comprise from 2 to 12 phr of a plasticizing system, this system comprising from 2 to 10 phr of at least one plasticizing resin with a glass transition temperature Tg of greater than or equal to 20° C., and preferably from 0 to 2 phr of a plasticizing agent that is liquid at room temperature. The preferred features of the plasticizing resin as described above and the preferred features of the plasticizing agent that is liquid at room temperature, when it is present, apply to this embodiment.

In another embodiment, the rubber composition of tires in accordance with the invention may be free of plasticizing agent that is liquid at room temperature (23° C.). In this case, the rubber composition of tires in accordance with the invention may comprise from 2 to 10 phr of a plasticizing system consisting of from 2 to 10 phr of at least one plasticizing resin with a glass transition temperature Tg of greater than or equal to 20° C.

### Various Additives

The rubber compositions of the tires in accordance with the invention may also include all or some of the usual additives customarily used in elastomer compositions intended to constitute external mixtures of finished rubber articles such as tires, in particular treads, for instance protective agents such as antiozone waxes, for instance paraffin, chemical antiozonants, antioxidants, anti-fatigue agents, pigments.

### Crosslinking System

The crosslinking system is preferentially a vulcanization system, that is to say a system based on sulfur (or on a sulfur-donating agent) and on a primary vulcanization accelerator. Various known secondary vulcanization accelerators or vulcanization activators, such as zinc oxide, stearic acid or equivalent compounds, or guanidine derivatives (in particular diphenylguanidine), or else known vulcanization retarders, may be added to this basic vulcanization system, being incorporated during the first non-productive phase and/or during the productive phase, as described subsequently.

When sulfur is used, it is used at a preferential content of between 0.5 and 12 phr, in particular between 1 and 10 phr. These preferential ranges apply to any of the embodiments of the invention. The primary vulcanization accelerator is used at a preferential content of between 0.5 and 10 phr, more preferentially of between 0.5 and 5.0 phr. These preferential ranges apply to any of the embodiments of the invention.

The content of sulfur used in the rubber composition of the tread in accordance with the invention is most often between 0.5 and 3.0 phr, and that of the primary accelerator is between 0.5 and 5.0 phr. These preferential ranges apply to any of the embodiments of the invention.

Use may be made, as (primary or secondary) accelerator, of any compound that is capable of acting as accelerator for the vulcanization of diene elastomers in the presence of sulfur, in particular accelerators of the thiazole type and also derivatives thereof, and accelerators of thiuram and zinc dithiocarbamate types. These accelerators are, for example, chosen from the group consisting of 2-mercaptobenzothiazyl disulfide (abbreviated to MBTS), tetrabenzylthiuram disulfide (TBZTD), N-cyclohexyl-2-benzothiazylsulfenamide (CBS), N,N-dicyclohexyl-2-benzothiazylsulfenamide (DCBS), N-(tert-butyl)-2-benzothiazylsulfenamide (TBBS), N-(tert-butyl)-2-benzothiazylsulfenimide (TBSI), zinc dibenzyldithiocarbamate (ZBEC), and mixtures of these compounds.

### Manufacture of the Composition and of the Tire

The rubber composition may be manufactured in appropriate mixers, using two successive phases of preparation according to a general procedure well known to those skilled in the art:
a first phase of thermomechanical working or kneading (sometimes referred to as a “non-productive” phase) at high temperature, up to a maximum temperature of between 130° C. and 200° C., preferably between 145° C. and 185° C. of the base constituents of the composition is performed, these constituents being the modified elastomer synthesized beforehand according to the process described above, the reinforcing filler, the coupling agent, the plasticizing system and the other ingredients with the exception of the vulcanization or crosslinking system, followed by
a second phase of mechanical working (sometimes referred to as a “productive” phase) at lower temperature, typically below 120° C., for example between 60° C. and 100° C., during which finishing phase the crosslinking or vulcanization system is incorporated.

The final composition thus obtained may be subsequently calendered, for example in the form of a sheet or slab, especially for laboratory characterization, or else extruded, to form, for example, a rubber profiled element used as a tread of a tire for a vehicle bearing heavy loads, especially for a heavy-duty vehicle or for a civil engineering vehicle.

The tire in accordance with the invention is preferably a tire intended to equip a vehicle bearing heavy loads, such as heavy-duty vehicles, buses, civil engineering vehicles. Preferentially, the tire in accordance with the invention is a tire intended to equip a heavy-duty vehicle.

The tire may be manufactured according to any process well known to a person skilled in the art.

The abovementioned characteristics of the present invention, and also others, will be understood more clearly on reading the following description of several implementation examples of the invention, given by way of illustration and without limitation.

### II—Examples of Implementation of the Invention

II-1. Measurements and Tests Used:

### Dynamic Properties

The dynamic properties and in particular tan(δ)ₘₐₓ, representative of the hysteresis, are measured on a viscosity analyser (Metravib VA4000) according to the standard ASTM D 5992-96. The response is recorded of a sample of the vulcanized composition (cylindrical test specimens with a thickness of 4 mm and a cross section of 400 mm²), subjected to a simple alternating sinusoidal shear stress, at a frequency of 10 Hz.

For the measurement of the modulus G* at 50% strain, noted as G*_{50%}, and of tan(δ)ₘₐₓ, a sweep is performed with a strain amplitude from 0.1% to 100% peak-to-peak (outward cycle), and then from 100% to 0.1% peak-to-peak (return cycle) at a temperature of 60° C. The results made use of are the complex dynamic shear modulus (G*) and the loss factor tan(δ). The maximum value of tan(δ) observed (tan(δ)ₘₐₓ) between the values from 0.1% to 100% strain are shown for the outward cycle.

For the measurement of tan(δ)_{-20° C.}, a temperature sweep is performed, under a stress of 0.7 MPa, and the tan(δ) value observed at −20° C. is recorded.

II-2 Preparation of the Rubber Compositions:

The procedure for the tests which follow is as follows: the functionalized or non-functionalized diene elastomer(s) are introduced into an 85 cm³ Polylab internal mixer, filled to 70%, the initial vessel temperature of which is about 110° C. Next, for all the compositions (control compositions and compositions of the invention), the optional reinforcing filler(s), the optional coupling agent and then, after kneading for one to two minutes, the various other ingredients, with the exception of the vulcanization system, are introduced into the mixer. Thermomechanical working is then performed (non-productive phase) in one step (total duration of the kneading equal to about 5 min), until a maximum “dropping” temperature of 160° C. is reached. The mixture thus obtained is recovered and cooled and the vulcanization system (sulfur) is then added on an external mixer (homofinisher) at 25° C., the whole being mixed (productive phase) for about 5 to 6 min.

The compositions thus obtained are subsequently calendered, either in the form of slabs (thickness of 2 to 3 mm) or of thin sheets of rubber, for the measurement of their physical or mechanical properties, or in the form of profiled elements which can be used directly, after cutting and/or assembling to the desired dimensions, for example as semi-finished products for tires, in particular as tire treads.

II-3 Test A:

The aim of this test is to demonstrate the improvement in the compromise of wet grip/rolling resistance/wear strength performance qualities of a composition in accordance with the invention relative to compositions not in accordance with the invention.

To do this, four compositions are compared, which differ from each other essentially in the technical characteristics that follow:
composition T1 is a composition not in accordance with the invention comprising a non-functionalized SBR of Tg=−65° C.;
composition T2 is a composition not in accordance with the invention comprising a non-functionalized SBR of Tg=−48° C.;
composition T3 is a composition not in accordance with the invention comprising an SBR of Tg=−65° C. functionalized by an amino-alkoxysilane function in the middle of the chain;
composition C₁ is a composition according to the invention comprising an SBR of Tg=−48° C. functionalized by an amino-alkoxysilane function in the middle of the chain.

Table 1 gives the formulation of the various compositions T1 to T3 and C₁; the contents are expressed in phr. All the compositions (T1 to T3 and C₁) comprise a crosslinking system conventionally used in the manufacture of tire treads; this crosslinking system comprising, in particular, sulfur, ZnO, stearic acid and an accelerator.

TABLE 1

| | T1 | T2 | T3 | C1 |
|---|---|---|---|---|
| SBR (1) | (−) | 80 | (−) | (−) |
| SBR (2) | 80 | (−) | (−) | (−) |
| SBR (3) | (−) | (−) | (−) | 80 |
| SBR (4) | (−) | (−) | 80 | (−) |
| BR (5) | 20 | 20 | 20 | 20 |
| Silica (6) | 65 | 65 | 65 | 65 |
| Carbon black (7) | 4 | 4 | 4 | 4 |
| Resin (8) | 10 | 10 | 10 | 10 |
| Coupling agent (9) | 6.5 | 6.5 | 6.5 | 6.5 |
| DPG (10) | 0.9 | 0.9 | 0.9 | 0.9 |
| Antioxidant (11) | 2 | 2 | 2 | 2 |
| Paraffin | 1 | 1 | 1 | 1 |

(1) Non-functional, non-extended solution SBR, with 24% of 1,2-polybutadiene units; 26.5% of styrene units and a Tg = −48° C.;
(2) Non-functional, non-extended solution SBR, with 24% of 1,2-polybutadiene units: 15.5% of styrene units and a Tg = −65° C.;
(3) Non-extended solution SBR functionalized with an amino-alkoxysilane function in the middle of the chain (more than 51% by weight relative to the weight of the elastomer), with 24% of 1,2 polybutadiene units; 26.5% of styrene units and a Tg = −48° C.; this copolymer was synthesized according to the process described in WO 2009/133068
(4) Non-extended solution SBR functionalized with an amino-alkoxysilane function in the middle of the chain (more than 51% by weight relative to the weight of the elastomer), with 24% of 1,2polybutadiene units; 15.5% of styrene units and a Tg = −65° C.; this copolymer was synthesized according to the process described in WO 2009/133068
(5) Neodymium polybutadiene with 98% of cis-1,4-butadiene units and a
Tg = −108° C.;
(6) Zeosil 1165MP silica of HDS type from Solvay;
(7) N134 carbon black;
(8) C₅/C₉ fraction resin sold by Cray Valley under the name THER 8644 resin (Tg = 44° C.);
(9) Coupling agent: TESPT (Si69 from Evonik-Degussa);
(10) Diphenylguanidine (Perkacit DPG from Flexsys);
(11) N-(1,3-dimethylbutyl)-N-phenyl-para-phenylenediamine sold by Flexsys under the name Santoflex 6-PPD.

The properties of the compositions after curing at 150° C. for 45 min are presented in table 2 below.

TABLE 2

| | T1 | T2 | T3 | C1 |
|---|---|---|---|---|
| G*50% (MPa) | 2.1 | 1.9 | 2.0 | 1.9 |
| tan(δ)max | 0.185 | 0.190 | 0.143 | 0.139 |
| tan(δ)_{-20° C.} | 0.389 | 0.631 | 0.331 | 0.673 |

From table 2, it is seen, for an equivalent stiffness (G*50% value), that composition T2 not in accordance with the invention comprising a non-functionalized high-Tg SBR allows, relative to composition T1 not in accordance with the invention comprising a non-functionalized low-Tg SBR, a significant improvement in the wet grip performance (tan(δ)_{-20° C.} value) accompanied by degradation of the rolling resistance performance (tan(δ)ₘₐₓ value). The compromise of wet grip/rolling resistance/wear strength performance qualities is not improved for composition T2 relative to composition T1 not in accordance with the invention.

Moreover, it is found, for an equivalent stiffness, that composition T3 not in accordance with the invention comprising a low-Tg SBR functionalized with an aminosilane function in the middle of the chain allows, relative to composition T1 not in accordance with the invention comprising a non-functionalized low-Tg SBR, a significant improvement in the rolling resistance performance, but at the expense of the wet grip performance. The compromise of wet grip/rolling resistance/wear strength performance qualities is not improved for composition T3 relative to composition T1 not in accordance with the invention.

Surprisingly, for equivalent stiffness, composition C₁ in accordance with the invention comprising a high-Tg SBR functionalized with an aminosilane function in the middle of the chain allows, relative to composition T1 not in accordance with the invention, a significant improvement both in the rolling resistance performance and in the wet grip performance. Composition C₁ in accordance with the invention thus has, surprisingly, an improved compromise of wet grip/rolling resistance/wear strength performance qualities relative to composition T1 not in accordance with the invention.

1. A tire intended to equip a vehicle bearing heavy loads, the tire comprising a tread including at least one rubber composition based on at least:
an elastomer matrix comprising at least one modified copolymer at a content greater than or equal to 51 phr, said modified copolymer having a glass transition temperature Tg strictly above −65° C. and below or equal to −30° C. and being composed of a copolymer based on styrene and based on butadiene functionalized in the middle of the chain with an alkoxysilane group linking the two arms of said copolymer via the silicon atom which bears an amine function bonded directly or via a spacer group to the silicon atom,
a reinforcing filler predominantly comprising silica,
a chemical crosslinking system,
an agent for coupling between said elastomeric matrix and said reinforcing filler,
a plasticizing system comprising from 2 to 15 phr, of at least one plasticizing resin having a glass transition temperature Tg of greater than or equal to 20° C., and of which the total content of the plasticizing system in the composition ranges from 2 to 17 phr.

2. A tire according to claim 1, in which the amine function of said modified copolymer is a primary, secondary or tertiary amine.

3. A tire according to claim 2, in which the amine function of said modified copolymer is a tertiary amine and is chosen from diethylamine and dimethylamine.

4. A tire according to claim 1, in which the amine function of said modified copolymer is borne by the alkoxysilane group via a spacer group.

5. A tire according to claim 4, in which the spacer group bearing the amine function of the modified copolymer is a C₁-C₁₈ aliphatic hydrocarbon-based radical.

6. A tire according to claim 1, in which the alkoxysilane group of the modified copolymer is methoxysilane or ethoxysilane, optionally partially or totally hydrolysed to silanol.

7. A tire according to claim 1, in which the modified copolymer has a glass transition temperature ranging from −60 to −40° C.

8. A tire according to claim 1, in which the elastomer matrix further comprises at least one second diene elastomer different from the modified copolymer.

9. A tire according to claim 8, in which the second diene elastomer is chosen from the group consisting of polybutadienes, natural rubber, synthetic isoprenes, butadiene copolymers other than butadiene-styrene copolymers, isoprene copolymers, and mixtures of these polymers and copolymers.

10. A tire according to claim 8, in which the content of the second diene elastomer ranges from 5 to 49 phr.

11. A tire according to claim 1, in which the composition also comprises carbon black.

12. A tire according to claim 1, in which the content of the reinforcing filler ranges from 55 to 200 phr.

13. A tire according to claim 1, in which the plasticizing resin has a glass transition temperature Tg of greater than or equal to 30° C.

14. A tire according to claim 1, in which the plasticizing resin is chosen from the group consisting of cyclopentadiene homopolymer or copolymer resins, dicyclopentadiene homopolymer or copolymer resins, terpene homopolymer or copolymer resins, C₅ fraction homopolymer or copolymer resins, C₉ fraction homopolymer or copolymer resins, mixtures of C₅ fraction homopolymer or copolymer resins and of C₉ fraction homopolymer or copolymer resins, α-methylstyrene homopolymer or copolymer resins, and mixtures of these resins.

15. A tire according to claim 1, in which the plasticizing system comprises from 0 to 2 phr of at least one plasticizing agent that is liquid at room temperature.

16. A tire according to claim 1, in which the composition is free of a plasticizing agent that is liquid at room temperature.

17. A tire according to claim 1, wherein the tire is intended to equip a heavy-duty vehicle or bus.

18. A tire according to claim 1, wherein the total content of the plasticizing system in the composition ranges from 2 to 12 phr.

19. A tire according to claim 5, in which the spacer group bearing the amine function of the modified copolymer is a linear C₂ or C₃ hydrocarbon-based radical.

20. A tire according to claim 9, in which the second diene elastomer is a polybutadiene.
